(19) United States
(12) Patent Application Publication
(10) Pub. No.: US 2025/0270791 A1
(43) Pub. Date: Aug. 28, 2025

(54) Electrical Power System for Earthmoving Machine

(71) Applicant: Caterpillar Inc., Peoria, IL (US)

(72) Inventors: Mo Wei, Dunlap, IL (US); Xinyu Ge, Peoria, IL (US); Jia J. Li, Peoria, IL (US)

(73) Assignee: Caterpillar Inc., Peoria, IL (US)

(21) Appl. No.: 18/588,556

(22) Filed: Feb. 27, 2024

(51) Int. Cl. E02F 9/20; E02F 3/32; E02F 3/43; E02F 9/22; H02J 4/00; H02J 7/00; H02J 7/34

(52) U.S. Cl. CPC E02F 9/2091; E02F 3/32; E02F 3/435; E02F 9/2095; H02J 7/0047; H02J 7/00712; H02J 7/345; E02F 9/2203; H02J 4/00

(57) ABSTRACT

An earthmoving machine includes a primary power source for supplying electrical power to one or more electrical motors during a work cycle and an auxiliary power source to supply supplemental power during a high load condition of the work cycle. To recharge the auxiliary power source, the total required recharging power can be determined and can be converted to a recharging power control setting to be applied during the low load condition of the work cycle. Recharging power can be directed from the primary electrical power source to the auxiliary power source in accordance with the recharging power control setting.

### TECHNICAL FIELD

This patent disclosure relates generally to an electrical power system for an earthmoving machine and, more particularly, to an arrangement and method of recharging an auxiliary power source included with the electrical power system.

### BACKGROUND

Earthmoving and material handling operations may rely on different types of equipment and machinery for digging and excavating the material of interest, physically moving the material, and dumping or loading the material at another location. An example of an earthmoving machine is an excavator, or excavating machine, which is used in excavating operations to dig and move earthen materials from a terrain surface. Excavators can include an elongated mechanical linkage with an excavating tool like a bucket attached at the distal end that can be spatially maneuvered by articulation of the linkage to dig and transport the material. Articulation of the linkage can be powered by hydraulic actuators and an associated hydraulic system to provide pressurized hydraulic fluid, although in some embodiments, a series of cables that are reeled in or paid out by an electrical motor may be utilized. Other examples of machines that may be used in excavating operations include bucket loaders equipped with articulable buckets, dozers having forward mounted blades, and the like.

The earthmoving machine may be a mobile machine that includes one or more traction/propulsion devices like continuous tracks or wheels for travel about a worksite to access and move the terrain material. To power the traction/propulsion devices, the excavating machine can be equipped with a power plant or power source. While earthmoving machines traditionally use internal combustion engines as the power source, more recently machines may use electrical power sources such as rechargeable batteries. In addition to powering the traction/propulsion devices, the electrical power source may provide for powered operation of the tool linkage.

The electrical power requirements of earthmoving machine may vary substantially depending upon the work operations undertaken. The components of the electrical power system can be configured to provide supplemental electrical power for an intermittent or temporary period during high load conditions. For example, U.S. Publication 2014/0147238 describes a construction machine in which a capacitor is operatively arranged with a battery to cooperatively power operation of the construction machine. The present disclosure is also directed to an arrangement and methods for providing supplemental electrical power during the operating cycle of an earthmoving machine.

### SUMMARY

The disclosure describes, in one aspect, an earthmoving machine that includes a machine frame supported on a plurality of traction/propulsion devices and a tool linkage coupled to a work tool to conduct a work cycle. The earthmoving machine can include a traction motor to power the traction/propulsion devices and hydraulic pump to actuate one or more hydraulic actuators associated with the tool linkage. The earthmoving machine also includes a primary power source to power the traction motor and an auxiliary power source to provide supplemental power to the hydraulic pump. An electronic controller included with the earthmoving machine is programmed to conduct a work cycle by moving the tool linkage that is characterized by a high load condition and a low load condition. The electronic controller is further programmed to covert a total required recharging power needed to recharge the auxiliary power source into a recharging power control setting that is applied during the low load condition to direct electrical recharging power to the auxiliary power source.

In another aspect, the disclosure describes a method of operating an earthmoving machine during a work cycle that is characterized by a high load condition and a low load condition. In accordance with the method, a total required recharging power is determined for recharging an auxiliary power source that is selectively connected with a primary power source. The total required recharging power is converted to a recharging power control setting that is applied during the low load condition. The method recharges the auxiliary power source in accordance with recharging power control setting.

In yet another aspect, the disclosure describes a computer-implemented control system for recharging an auxiliary power source on an earthmoving machine. The control system includes a recharge determination routine/module configured to determine a total required recharging power to recharge the auxiliary power source after discharging supplemental power during a high load condition of the work cycle. The control system also includes an allocation-conversion routine/module to convert the total required recharging power into a recharging power control setting to be applied during a low load condition of the work cycle.

### BRIEF DESCRIPTION OF THE DRAWINGS

FIG. 1 is a side elevational view of an example of an earthmoving machine such as a hydraulic excavator for material moving operations that includes an electric powertrain.

FIGS. 2A and 2B are schematic block diagrams of an earthmoving work cycle that may be partitioned into a high load cycle segments and low load cycle segments having different power requirements.

FIG. 3 is a schematic representation of an electrical power system for the earthmoving machine including an auxiliary power source arranged to be recharged by a primary power source.

FIG. 4 is a flow diagram of a computer-implemented recharging process configured to determine a total required recharging power and to convert that to a recharging power control settings for allocating recharging power during low load conditions of the earthmoving work cycle.

FIG. 5 is a chart of electrical power discharge from and recharged to the auxiliary power source during the earthmoving work cycle.

### DETAILED DESCRIPTION

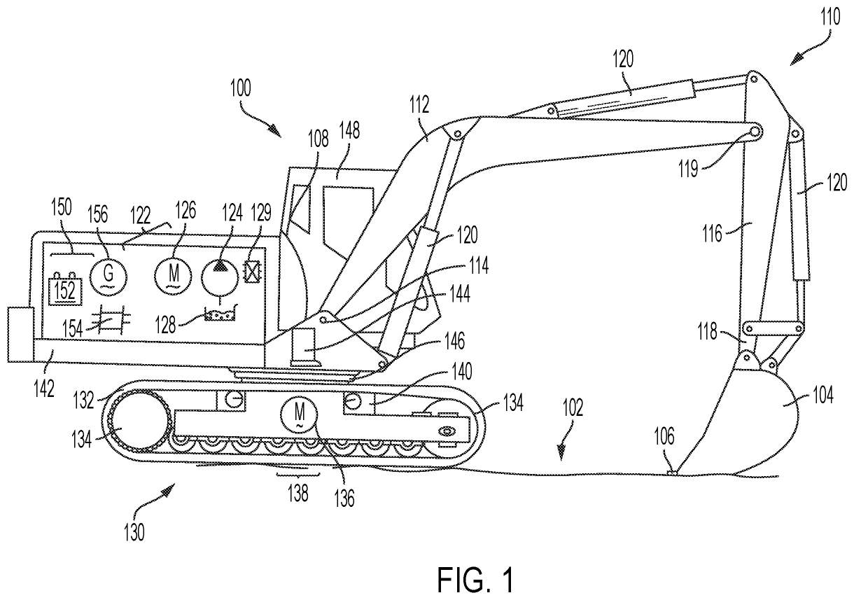

Now referring to the drawings, wherein whenever possible like reference numbers refer to like features, there is illustrated in FIG. 1 an example of a mobile earthmoving machine 100 in the embodiment of a hydraulic excavator for digging and loading earthen materials and similar matter from the terrain surface 102 of a worksite. To penetrate the terrain surface 102 and accommodate the earthen soil or construction material, the earthmoving machine 100 includes a work tool in the form of a bucket 104 that is shaped to define an opened volume and includes a cutting or leading edge 106 at its furthermost tip. The bucket 104 can be movably connected with the structural machine frame 108 of the earthmoving machine 100 by an articulating tool linkage 110, such that the bucket or another work tool can be maneuvered with respect to the terrain surface 102. The earthmoving machine 100 can range in various sizes from compact excavators to excavators used in mineral extraction.

In addition to an excavator equipped with a bucket, another example of a mobile earthmoving machine 100 can be a bucket loader, such as a wheeled loader or track loader. The bucket loader can include a forward mounted bucket connected to the machine frame that can be vertically raised and lowered with respect to the terrain surface during loading and dumping operations. Other examples of mobile earthmoving machines 100 suitable for earthmoving and terrain shaping operations include dozers having a work tool embodied as a forward mounted blade, graders, hammers and the like. In another embodiment, the earthmoving machine may take the form of an attachment that can be operatively coupled to another type machine such as a loader. Furthermore, aspects of the disclosure may be applicable to other types of machines for conducting operations associated with an industry such as mining, construction, farming, transportation, and the like.

To extend, retract, and maneuver the bucket 104 with respect to the terrain surface 102, the tool linkage 110 connecting the bucket to the machine frame 108 can be a mechanical assembly of rigid links that are movably connected by mechanical joints so that the assembly can articulate with respect to itself. For example, the tool linkage 110 can include an elongated arm or boom 112 that is pivotally connected to the machine frame 108 at a proximal end joint 114 of the linkage and a second elongated arm or dipper stick 116 that is pivotally joined to the bucket 104 at the distal end joint 118 of the linkage. The boom 112 and the dipper stick 116 can be made from rigid structural steel and can be pivotally connected together by a revolute arm joint 119 so that the elongated links can articulate with respect to each other.

To cause the boom 112, dipper stick 116, and bucket 104 to articulate with respect to each other, the tool linkage 110 can be operatively associated with one or more hydraulic actuators 120 such as, for example, hydraulic cylinders that can telescopically extend and retract an elongated rod attached to a piston movably accommodated in a cylinder body thereby resulting in lifting, tilting, and other motions. For example, the tool linkage 110 can include a boom actuator, a stick actuator, and a bucket actuator operatively arranged to pivotally articulate the rigid linkages that correspond to the boom 112, the dipper stick 116, and the bucket 104.

To provide pressurized hydraulic fluid for use by the hydraulic actuators 120, the earthmoving machine 100 can be associated with a hydraulic system 122 including a hydraulic pump 124 powered by an electric pump motor 126, which are disposed on the machine frame 108. The hydraulic pump 124 can be supplied hydraulic fluid from a hydraulic reservoir 128 or tank and can direct the pressurized hydraulic fluid to the plurality of hydraulic actuators 120 through a distribution valve 129. The hydraulic pump 124 can be any suitable type of volumetric fluid displacement pump such as a gear pump, piston pump, swash plate, and the like. The electric pump motor 126 can convert electricity in the embodiment of, for example, direct current to rotational motion and torque. The electric pump motor 126 is operatively coupled to the hydraulic pump 124 through rotatable shafts.

To enable the earthmoving machine 100 to travel over the terrain surface 102 at the worksite, the machine frame 108 can be supported on a plurality of traction/propulsion devices 130. By way of example, the traction/propulsion devices 130 can be continuous tracks 132 that extend about one or more rotatable drive gears 134 that cause the tracks to traverse with respect to the terrain surface 102. In another example, the traction/propulsion devices 130 can be rotatable pneumatic wheels. To power the traction/propulsion devices 130, an electric traction motor 136 can be disposed on the machine frame 108 to convert DC electricity to a rotational motive output and torque. To vary the rotational speed and or direction, and relatedly the torque output, of the traction motor 136, the traction motor can be an operative component of a traction powertrain 138 that may include components like transmissions, differentials, etc.

In an embodiment, the earthmoving machine 100 can be configured to swing the tool linkage 110 with respect to the terrain surface 102 as part of the terrain moving work cycle. For example, the machine frame 108 can be assembled from an undercarriage 140 that is associated with the traction/propulsion devices 130 and a platform 142 that is situated above the undercarriage 140. The undercarriage 140 and the platform 142 are coupled by a swing drive motor 144 and a ring gear 146 that rotate the tool linkage 110 to different locations over the terrain surface 102 during a terrain moving operation.

To operate the earthmoving machine 100, the platform 142 can include an onboard operator station 148 or operators cab to accommodate an operator. The earthmoving machine 100 can also be configured for autonomous, semi-autonomous, or remote operation. In autonomous operation, the earthmoving machine 100 may utilize various sensors and controls to conduct operations without human interaction. In semi-autonomous operation, a human operator may conduct some of the tasks and assume some control over the earthmoving machine 100, while the machine itself may be responsible for other operations. In remote configurations, the operator may be located off-board and away from the earthmoving machine 100 and control it through a remote control system.

In an embodiment, the earthmoving machine 100 can utilize an electrical power source to power operation of the machine in any of the foregoing modes of operation. To provide the electrical power, a power plant in the form of a primary power source 150 can be disposed on the machine frame 108. The primary power source 150 can be the primary driver of the traction/propulsion devices 130 connected through the traction motor 136 for mobility of the earthmoving machine 100 with respect to the terrain surface 102. The primary power source 150 can also be electrically connected with the pump motor 126 to power the hydraulic system 122 and can also power the swing drive motor 144 to swing the platform 142.

To generate electric power for earthmoving machine 100, the primary power source 150 can be embodied as any suitable source of electrical energy to provide and supply electrical power in the form of electrical current and voltage to a load. The primary power source 150 can produce electrical power as either direct current or alternating current, and the alternating electrical current can be single phase or polyphase electricity. The primary power source 150 can produce electrical power utilizing any suitable technology and operating principle include electromagnetic, thermodynamic, chemical, solar, etc.

The primary power source 150 can be, for example, a battery pack 152 comprised of a plurality of electro-chemical battery cells that function as an energy storage system for electricity. The battery pack 152 can store and supply direct current electricity and the individual battery cells that can be secondary rechargeable cells cable of being periodically charged, discharged, and recharged. The individual electrochemical cells can be assembled in modules, and the modules can be structurally assembled together as a battery pack 152 for facilitating electrical connectivity and mounting to the machine frame 108. In other embodiments, the primary power source 150 can be a fuel cell 154 that converts the chemical energy of a fuel such as hydrogen into electrical energy. In yet another example, the power source 150 can be an electrical generator 156 that is coupled to the output shaft of the internal combustion engine to receive motive power in the form of rotational torque. A generator 156 converts motive power embodied as rotational motion into electrical power in the form of alternating electrical current that can be converted to direct current using a power converter.

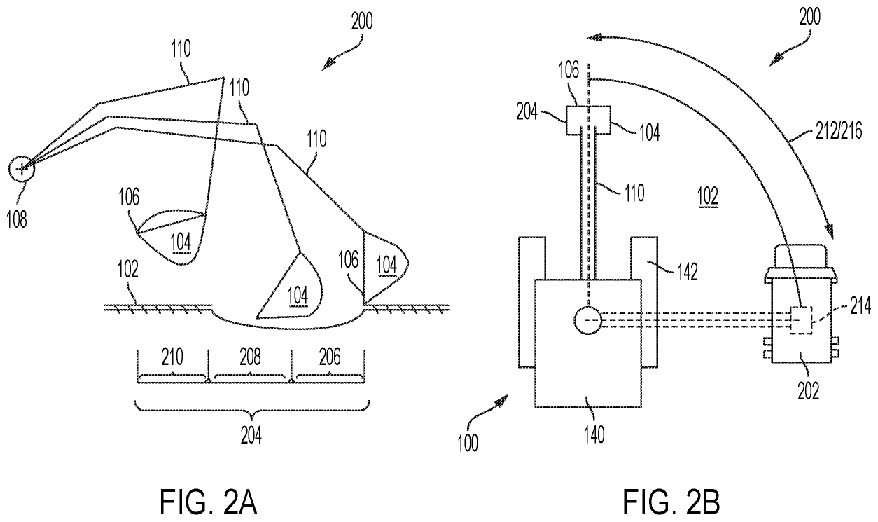

Primary power source 150 can be responsible for electrically powering the earthmoving machine 100 through a series of operations and maneuvers to conduct a work related task, which may be referred to as a work cycle. As may be common in large scale earthmoving operations, the work cycle may be repeated several times to accomplish the desired result. For example, referring to FIGS. 2A and 2B, in the embodiment wherein the earthmoving machine 100 is an excavator, a typical work cycle 200 can be an excavation cycle or terrain moving work cycle to move earthen materials and terrain from one location to another location, for example, a haul truck 202. The work cycle 200 may be partitioned into a series of distinct sequential operations and maneuvers conducted in a continuous, repeated pattern. The work cycle 200 including the plurality of sequential cycle segments that can be conducted manually by an operator, semi autonomously, or fully autonomously.

To load the haul truck 202, the work cycle 200 can be begin with a dig-stroke segment 204 in which the bucket 104 or similarly terrain moving tool is moved adjacent to the plane of the terrain surface 102 at the worksite by manipulation of the tool linkage 110. At the beginning of the dig-stroke segment 204, the leading edge 106 of the bucket 104 may be in abutting contact with the plane of the terrain surface 102. The dig-stroke segment 204 may also be distinguished into a plurality of sub-segments. For example, referring to FIG. 2A, the tool linkage 110 is hydraulically powered to vertically drive the leading edge 106 of the bucket 104 into and penetrate the terrain surface 102, which may be referred to as the penetration or break-in sub-segment 206. The break-in sub-segment 206 can be characterized by relatively large forces necessary to initiate penetration of the terrain surface 102, thereby requiring the excavating machine 100 to generate a correspondingly large quantity of power for maneuvering the tool linkage 110.

The dig-stroke segment 204 can continue by moving the bucket 104 along and vertically into the terrain surface 102 toward the earthmoving machine 100 thereby filling the bucket with material in what can be referred to as a dig-in sub-segment 208. Once the bucket 104 is moved proximate to the earthmoving machine 100 and the dig-in sub-segment 208 is compete, the bucket 104 may be vertically lifted from the terrain surface 102 to remove the excavated material in what can be referred to as loaded lift sub-segment 210. The bucket 104 can also be angularly curled with respect to the tool linkage 110 to better situate the material therein.

When the bucket 104 is filled with the material, the work cycle 200 can include a loaded swing segment 212 to maneuver the bucket from the location of the dig-stroke segment 204 toward the haul truck 202. Referring to FIG. 2B, during the loaded swing segment 212, the platform 142 is rotated with respect to the undercarriage 140 about the vertical axis of the earthmoving machine 100 by the swing machinery. When the bucket 104 is positioned over the haul truck 202 (indicated in dashed lines) the work cycle 200 can include a dump segment 214 in which the bucket 104 is pivoted with respect to the tool linkage 110 to release the material therein. After the bucket 104 has been empty to the haul truck 202, the work cycle 200 includes an empty swing segment 216 in which the platform 142 rotates the tool linkage 110 again with respect to the terrain surface 102 to position the bucket 104 for the next dig-stroke segment 204.

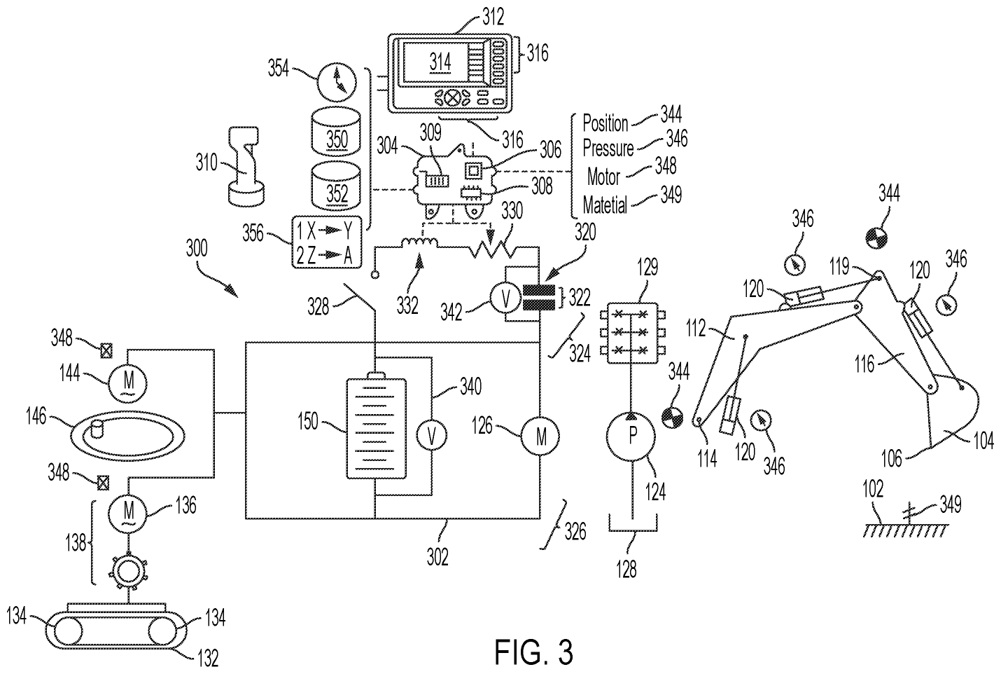

Referring to FIG. 3, to regulate electrical power supplied from the primary power source 150 during the work cycle, a computerized battery management system 300 can be included and associated with the various systems and functions of the earthmoving machine 100. The battery management system 300 can be capable of monitoring parameters and electrical characteristics associated with the primary power source 150 such as voltage and/or current flow into and discharged from, for example, the battery pack 152. The battery management system 300 can also calculate different values associated with the operation and physical state of battery pack 152. The battery management system 300 is therefore able to manage and regulate electrical operation of the various systems connected with and powered by the primary power source 150.

In particular, to connect and direct electrical power from the primary power source 150, the battery management system 300 can control and be responsible for the operation of a power bus 302 comprised of conductive wires, power cables, and similar conductors for the transmission of electricity. The power bus 302 can be attached to and routed by the machine frame 108 to physically and electrically connect with the pump motor 126 associated with the hydraulic system 122. The battery management system 300 can therefore be partially responsible for the operation of the hydraulic actuators 120 operatively associated with the tool linkage 110 to move and maneuver the bucket 104. The power bus 302 can also electrically connect the primary power source 150 with the traction motor 136 to power the traction/propulsion devices 130 and the swing drive motor 144 to swing the platform 142 with respect to the undercarriage 140. The power bus 302 may be capable of conducting electricity in any phase and power rating necessary for the intended application.

To provide computerized functionality for battery management system 300, an electronic controller 304 can be included and disposed on the earthmoving machine 100. The electronic controller 304 can include various circuitry components in any suitable computer architecture for receiving and processing data and software to operate. The electronic controller 304 can process and execute different functions, steps, routines, and instructions written as computer readable software programs and may use data from sources such as data tables, charts, data maps, lookup tables and the like. Additionally, the electronic controller 304 can be responsible for processing functions associated with various other systems on the earthmoving machine 100. While the electronic controller 304 is illustrated as a standalone device, its functions may be distributed among a plurality of distinct and separate components.

For example, the electronic controller 304 can include one or more microprocessors 306 such as a central processing unit (CPU), an application specific integrated circuit (ASIC), or a field programmable gate array (FPGA) comprising a plurality of transistors and similar circuits that are capable of reading, manipulating and outputting data in electronic form. The electronic controller 304 can include non-transient programmable memory 308 or other data storage capabilities such as random access memory or more permanent non-volatile forms of data storage media. Common examples of computer-readable memory 308 include RAM, PROM, and EPROM, a FLASH-EPROM, and any other memory chip or cartridge. The memory is capable of storing in software form the programming instructions and the data that can be read and processed by the microprocessor 306. The software and data may take the form of instruction sets, programs, applications, routines, libraries, databases, lookup tables, data sets, and the like. To communicate with other instruments and actuators associated with and electrically connected to the power bus 302, the electronic controller 304 can include various input/output cards 309 and related circuitry. Communication may be established by sending and receiving digital or analog signals across electronic communication lines or communication busses using any suitable data communication protocols, including wireless protocols.

In an embodiment, to interface with an operator of the earthmoving machine 100, the electronic controller 304 can be operatively associated with and communicate with one or more operator interface devices. For example, to receive operator commands to maneuver the traction/propulsion devices 130 and the tool linkage 110 during operation, an operator input device such as a joystick 310 can be included onboard in the operator station 148 or off-board for remote control. During a terrain moving work cycle, the joystick 310 can be pivoted in multiple directions, and the movements of the joystick triggered by an operator are converted to electronic signals to the electronic controller 304 that adjust operation of the hydraulic system 122 to lift, lower, extend and/or retract the tool linkage 110 with respect to the terrain surface 102. In addition to the joystick 310, other examples of input devices for maneuvering may include steering wheels, gear sticks, and the like.

To further interface with the operator, a display device in the embodiment of a human-machine interface (HMI) 312 can be included. The HMI 312 can include visual display screen 314 such as an LCD screen that may have touch screen capabilities. Information regarding operation of the earthmoving machine 100 can be visually presented on the visual display screen 314 for the operator such as the operating speed of various systems, operational settings like gear selection, and the relative position and location of various structures like the tool linkage 110 and the angular position of the platform 142. To receive operational settings, the HMI 312 may also include tactile inputs 316 like buttons, keys, dials, etc. Tactile inputs 316 can also be located on the joystick 310.

The battery management system 300 can be configured to regulate and manage the supply of electrical power from the primary power source 150 responsive to the different cycle segment of the terrain moving work cycle 200 that, as described above, are associated with different force and power requirements. For example, referring to FIGS. 2B, the dig-stroke segment 204 may require substantial power to cause the leading edge 106 of the bucket 104 to penetrate and move through the terrain surface 102 compared with the swing and dump segments 212, 214, 216. In particular, penetration and displacement of the terrain surface 102 with the bucket 104 through movable articulation with the tool linkage 110 requires the hydraulic system 122 to produce and apply substantial hydraulic pressures to the hydraulic actuators 120. The pump motor 126 therefore must draw electrical power in a proportionally substantial quantity from the primary power source 150.

Furthermore, the electrical power requirements, or load, across an individual cycle segment may also vary. For example, referring to FIG. 2A, during the break-in sub-segment 206 of the dig-stroke segment 204, the forces required may relatively large to drive the leading edge 106 of the bucket 104 into and fracture the terrain surface 102. By contrast, once the leading edge 106 has penetrated a sufficient depth into the terrain surface 102, the force requirements to move the bucket 104 through the material during the dig-in sub-segment 208 may lessen or abate.

The variations in power demand over the work cycle 200 may be characterized or categorized as high load condition or segment and low load conditions or segments in relation to the electrical power consumed. With respect to the terrain moving work cycle 200, the dig-stroke 204 is a high load condition or segment and the swing and dump segments 212, 214, 216 are, in contrast, relatively low load conditions or segments. The battery management system 300 may be physically and functionally arranged to accommodate the address the varying power requirements between the high load and low load conditions.

For example, to provide supplemental electrical power during the high load conditions, an auxiliary power source 320 can be included with the battery management system 300. The auxiliary power source 320 can be disposed in electrical connection with and can cooperatively interact with the primary power source 150 to deliver supplemental electrical power in excess of the power otherwise available on an intermittent or as needed basis. The auxiliary power source 320 therefore reduces the size and/or capacity required of the primary power source 150. The auxiliary power source 320 also reduces the power drawn on the primary power source 150, and relatedly the electrical current flowing there from, which may reduce the potential for overheating and damage to the electrical connections between, for example, the battery pack 152 and the power bus 302.

In an embodiment, the auxiliary power source 320 can be a capacitor 322 designed for the temporary storage of electrical energy when operatively connected to a direct current electrical circuit. In a specific embodiment, the capacitor 322 may be a super capacitor with significant storage capacity and delivery of electrical power during a charge-and-discharge cycle. The capacitor 322 can be constructed with opposing conductive electrodes separated by a non-conductive dielectric or electrolyte. During charging, an electrical charge builds between the separated electrodes. During discharge, the circuit is reconfigured and the charge is withdrawn from the electrodes as current thereby providing auxiliary power during the high load condition. In addition to a capacitor, examples of an auxiliary power source 320 include secondary batteries, fuel cells, and other temporary electrical power storage systems.

Referring to FIG. 3, the auxiliary power source 320 can be physically included as part of an auxiliary circuit 324 connected in common with the primary power source 150 by the conductive power bus 302. For example, the auxiliary circuit 324 can be arranged in parallel with and selectively connectable with a primary circuit 326 of the power bus 302 that establishes electrical communication between the primary power source 150 and the pump motor 126, the traction motor 136, and the swing drive motor 144.

To selectively establish electrical communication with the auxiliary power source 320, the auxiliary circuit 324 can include an electric switch 328. The electric switch 328 can be toggled opened or closed to complete or interrupt the electrical connection between the auxiliary power source 320, the primary power source 150, and the pump motor 126. For example, when the electric switch 328 is in the closed state, the auxiliary power source 320 is electrically connected to and communicates with the primary power source 150 to receive electrical current therefrom and is thereby charged.

In an embodiment, to regulate the electrical power and current directed from the primary power source 150 to the auxiliary power source 320 when the electric switch 328 is closed, the auxiliary circuit 324 can include a current regulator 330 and a current sensor 332. The current regulator 330 and the current sensor 332 are connected in series with the auxiliary power source 320 and can adjust the level and rate of electrical power, for example quantified in terms of current, flowing thereto. The current sensor 332 can measure the electric current in the auxiliary circuit 324 in terms of amps and may be embodied as an ammeter. The current regulator 330 is an adjustable device that can restrict or enlarge the current flow in the auxiliary circuit 324 and can be embodied as a potentiometer or adjustable resistor. The current regulator 330 and the current sensor 332 can be cooperatively arranged together, and may be operatively associated with the electronic controller 304, to provide responsive and active adjustments to the current flow in the auxiliary circuit 324.

When the electric switch 328 is in the opened state, the electrical connection between the auxiliary power source 320 and the primary power source 150 is interrupted. Because the auxiliary power source 320 is still connected in series with the pump motor 126, the stored electrical power in the capacitor 322 is discharged to the pump motor 126. The electrical power discharged to the pump motor 126 in the embodiment of electric current supplements the power supplied by the primary power source 150 increasing the torque and mechanical output of the pump motor 126 to the hydraulic system 122 during the high load conditions.

To facilitate the selective charging and discharging of the auxiliary power source 320, the battery management system 300 can be configured to actively monitor and respond to the work cycle 200 conducted by the earthmoving machine 100. In particular, the electronic controller 304 can be programmed to receive, process, and analyze information about the operations and activities of the earthmoving machine 100 that may be provided by a plurality of sensors. A sensor can be capable of sensing and/or measuring a physical condition or characteristic of the surrounding environment and communicating that information to the electronic controller 304 as electronic data signals. The sensors can work upon any suitable operating principle for the assigned task, and may make mechanical, electrical, visual, and/or chemical measurements.

For example, to measure the state of charge of the primary power source 150, which quantifies the available capacity at a given time, a primary power sensor 340 can be operatively associated there with. In an embodiment, the primary power sensor 340 can be a voltage sensor that is connected across the positive and negative terminals of the primary power source 340 to determine the voltage potential. The measured voltage potential can be converted to the current state of charge of the primary power source 150 using known equations. The primary power sensor 340 can also be configured to measure additional electrical parameters associated with the primary power source 150. For example, the primary power sensor 340 may also measure power or current flow to or from the primary power source 150 using a coulomb counting method. To measure similar electrical characteristics and values of the auxiliary power source 320, it may be operatively associated with an auxiliary power sensor 342.

To sense the position and actions of the tool linkage 110, one or more linkage sensors can be associated there with. For example, to determine the position and locational arrangement of the tool linkage 110, rotary encoders 344 can be attached proximate to the proximal end joint 114, the distal end joint 118, and the revolute arm joint 119 of the tool linkage 110. The rotary encoders 344 can measure the relative angular displacement between two rigid links, for example, the boom 112 and the dipper stick 116. Using dimensional data associated with the tool linkage 110 and kinematic equations that may be saved in the memory 308 of the electronic controller 304, the relative position and movement of the bucket 104 with respect to the terrain surface 102 can be determined.

In another embodiment, the linkage sensors can be fluid pressure sensors 346 operatively associated with the hydraulic actuators 120 attached to the tool linkage 110. The fluid pressure sensors 346 can measure the hydraulic fluid pressure in the hydraulic actuators, which may be indicative of the forces and strains applied to the tool linkage 110 and may be proportional to the power requirements of the hydraulic system 122. The fluid pressure in the hydraulic actuators 120 can also be indicate of the extension and retraction of the actuators 120, which, through dimensional data and kinematic equations, can be converted to determine the spatial motion and positions of the tool linkage 110.

To measure other operational conditions and activities of the earthmoving machine 100, motor sensors 348 can be associated with the various electric motors, including the pump motor 126, the traction motor 136, and the swing drive motor 144, driving movement of the machine. The motor sensors 348 can measure various outputs and values of the electric motors such as angular movement, rotational speed, and torque. Data from the motor sensors 348 can reflect the current activities of the earthmoving machine 100, and thus the electrical power requirements. Examples of motor sensors 348 include Hall Effect sensors, inductive sensors, optical sensors, and virtual sensors configured to indirectly compute motor output from different parameter measurements.

The power requirement of the earthmoving machine 100 may be related and influenced by the conditions and characteristics of the material and terrain being moved. Material data can therefore be obtained by one or more material sensors 349 associated with the earthmoving machine 100. The material sensors 349 can assess qualities and values associated with terrain surface 102 like material density or weight, material hardness, temperature, moisture content, etc. The material sensors 349 can concurrently collect the material data during operation of the earthmoving machine 100, for example, simultaneously with the work cycle. Material data may also be collected by the material sensors 349 in advance of the work cycle and can be maintained as data stored in the memory 308 of the electronic controller 304.

To enable the electronic controller 304 to make the necessary analysis and computations to responsively manage the work cycle, computer readable data related to the power requirements corresponding to the different cycle segments can be maintained in a power requirements database 350. The data in power requirements database 350 can be predetermined by design or obtained by empirical testing and can stored in the form of lookup tables, graphs, or power curves. Data values obtained from the various sensors associated with the earthmoving machine 100 can be referenced to the power requirements database 350 to assess or estimate the electrical power requirements during the different cycle segments.

Information about the work cycles can be stored in and obtained from a work cycle database 352 that is associated with the electronic controller 304. The information and data included in work cycle database 352 can reflect operating procedures and settings associated with the work cycle, for example, the instructions and actions for sequentially conducing the dig-stroke, swing, and dump segments of the earthmoving work cycle. The work cycle database 352 can include sequence timings and duration, range and speed settings for angular and linear motions, and other information necessary for conducting the work cycle. Because the work cycle data and settings may be time dependent, a digital counter 354 or clock for timing can be associated with the work cycle database 352.

In embodiments wherein the cycle segments and work cycle are repetitive and sequential, the data and information in the work cycle database 352 can be organized in instruction sets 356 for automatically conducting a complete work cycle. For example, during autonomous operation of the earthmoving machine 100, the electronic controller 304 can read the instruction set 356 including the necessary instructions and commands for sequentially executing the cycle segment of the work cycle and consequentially direct powered operation of the electrical motors to induce movement in accordance with the work cycle. The instruction set 356 may also include settings and instructions for the battery management system 300 to facilitate distribution of electrical power during the work cycles.

### INDUSTRIAL APPLICABILITY

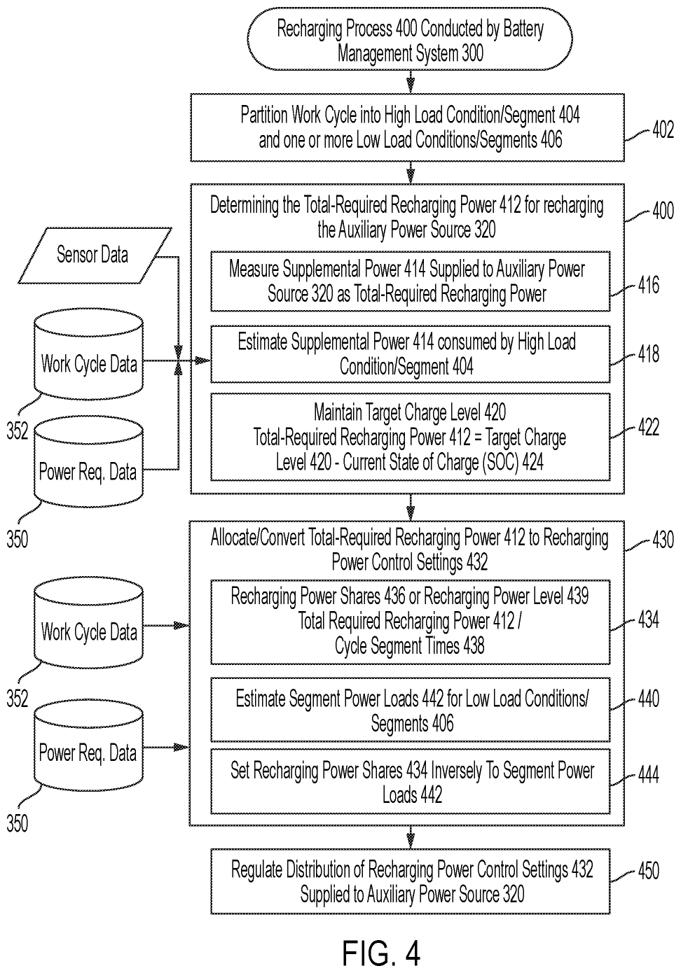

Referring to FIG. 4, with continued reference to the preceding figures, there is illustrated an embodiment of a computer implemented recharging process 400 for managing and regulation of electrical power usage during the work cycle, for example, an earthmoving work cycle 200, conducted by the earthmoving machine 100. The recharging process 400 may include a series of computer executable steps and operations and the may be embodied as a computer program or application written in a software programming language. The process 400 can be associated with and part of the battery management system 300, and the steps and operations may be executed by the electronic controller 304. An aspect of the recharging process 400 may be the management and regulation of the discharging and recharging of the auxiliary power source 320.

During the work cycle 200, the power requirements of the earthmoving machine 100 may correspond with the high load condition, for example, when the work cycle is conducting a high load segment. Referring to FIGS. 2A and 2B, the earthmoving work cycle 200 may be conducting the dig-stroke segment 204 requiring substantial hydraulic pressure generation by the hydraulic system 122 and, correspondingly, a substantial torque production by the pump motor 126. During another type of a work cycle, the high load condition may correspond with the increased power consumption of the traction motor 136 associated with the traction propulsion devices 130, for example, when a bucket loader penetrates and digs into a material pile.

To accommodate the increased electrical load demanded by the high load condition, the auxiliary power source 320 can be discharged to direct the supplemental power stored therein to the pump motor 126. In particular, the battery management system 300 can discharge the auxiliary power source 320 by having the electronic controller 304 open the electric switch 328 in the auxiliary circuit 324 to establish electrical communication between the auxiliary power source 320 and the pump motor 126. The supplemental electrical charge stored in the auxiliary power source 320 is communicated to the pump motor 126 in the form of increased electric current that correspondingly increases the torque output.

After discharge and supplying supplemental power to fulfill the high load condition, the battery management system 300 may recharge the auxiliary power source 320 in accordance with the recharging process 400. The recharging power may be supplied from the primary power source 150, although in possible embodiments, recharging power may be provided from other sources such as regeneration or grid power. To recharge the auxiliary power source 320, the electric switch 328 can close establishing electrical connection between the primary power source 150 and the auxiliary power source 320. The battery management system 300, via the electronic controller 304, can be configured to execute the recharging process 400 to regulate the power transfer between the primary power source 150 and the auxiliary power source 320. For example, the electronic controller 304 can use the adjustable current regulator 330 and current sensor 332 to selectively control the flow of electric current in the auxiliary circuit 324.

To recharge the auxiliary power source 320, the computer implemented recharging process 400 can include a plurality of routines or modules for determining the recharging power needed to efficiently distribute the power to the auxiliary power source 320 to avoid possible damage or harm to the auxiliary and primary circuits 324, 326. The routines and modules can be callable components of the battery management system 300 and can be configured to interface and exchange data and information with, for example, the sensor and can include implementation functionality to process the data and information to manage power distribution.

The routines and modules can be associated with and implemented during different cycle segments of the work cycle 200. The recharging process 400 therefore includes a cycle segmentation step 402 in which the work cycle 200 is partitioned into distinct identifiable segments and which can be classified as high load conditions or segments 404 and low load conditions or segments 406. For example, the dig-stroke segment 204 may be characterized as a high load condition 404 and the swing and dump segments 212, 214, 216 can be respectively characterized as low load conditions 406.

To determine the power necessary to replenish the auxiliary power source 320 after discharge, the recharging process 400 can include a recharge determination routine/module 410 to determine the total required recharging power 412. The total required recharging power 412, which may be referenced in wattage, corresponds to the electrical power that will be transferred from the primary power source 150 to the auxiliary power source 320. The recharge determination routine/module 410 can determine the total required recharging power 412 by any suitable methodology.

For example, the total required recharging power 412 may be equated with the supplemental power 414 that was discharged from the auxiliary power source 320 and thus consumed by the high load condition 404. The supplemental power 414 may be directly measured in a measurement step 416 from the auxiliary power source 320, for example, by use of the auxiliary power sensor 342 to measure the current flow or count the coulombs discharged by the auxiliary power source 320. The supplemental power 414 measured by the measurement step 416 is the actual power discharged from the auxiliary power source 320.

In another example, the supplemental power 414 consumed by the high load condition 404, and thus drawn from the auxiliary power source 320, can be estimated. In an estimation step 418, the electronic controller 304 can use data and information from the sensors to estimate the supplemental power 414 from parameters and values such as the volume or weight of material moved during the earthmoving work cycle 200, the duration of the earthmoving work cycle 200, power consumption or ratings about the electrical motors that can be obtained from the motor sensors 348, the material characteristics of the terrain surface 102 that can be obtained by the material sensors 349, etc. In an embodiment, the estimation step 418 can utilize information and data about the motions and applied forces on the tool linkage 110, for example as obtained from the rotary encoders 344 and/or pressure sensors 346, to estimate the energy expended during the work cycle 200. Additional values and information for estimating the supplemental power 414 consumed can be stored and retrieved from the power requirements database 350 and the work cycle database 352.

In addition to setting the total required recharging power 412 equal to the supplemental power 414 consumed by the high load condition 404, the recharge determination routine/module 410 can determine the total required recharging power 412 based on the capacity of the auxiliary power source 320. For example, the auxiliary power source 320 may be associated with a target charge level 420 that represents the power or energy level desired. The target charge level 420 may be less that a maximum capacity of the auxiliary power source 320 to avoid overcharging. The target charge level 420 can be obtained from performance ratings associated with auxiliary power source 320.

To determine the total required recharging power 412 needed to restore the auxiliary power source 320 to the target charge level 420, the target maintenance operation 422 can measure the current state of charge (SoC) 424 of the auxiliary power source 320. The current state of charge 424 of the auxiliary power source 320 can be measured by, for example, the auxiliary power sensor 342. The target maintenance operation 422 may subtract the current state of charge 424 from the target charge 422 and the difference can correspond to the total required recharging power 412 to supply from the primary power source 150 to the auxiliary power source 320.

To distribute in gradual amounts the total required recharging power 412 as determined by the recharge determination routine/module 410, the recharging process 400 can include an allocation-conversion routine/module 430 that partitions and converts the total required recharging power into a recharging power control setting 432. The electronic controller 304, in implementing the battery management system 300, can utilize the recharging power control setting 432 to control the auxiliary circuit 324 and regulate electrical power therein to recharge the auxiliary power source 320 in a manner that reduces electrical power spikes or rapid electric power transfers that may be detrimental to the primary and/or auxiliary power sources 150, 320.

The recharging power control settings 432 can be characterized or embodied as a plurality of recharging power shares or a recharging power level. For example, the total required recharging power 412 can be partitioned and allocated into a plurality of distinct recharging power shares. The plurality of recharging power shares can represent discrete units of power or energy that are sequentially directed to the auxiliary power source 320 in a gradual manner. As another example, the recharging power level may be the level or the controlled limit placed on the transfer of electrical recharging power through the auxiliary circuit 324 to the auxiliary power source 320, and may be referenced in electrical power units such as watts or electrical energy such as joules.

The plurality of recharging power shares and/or the recharging power level that correspond to the recharging power control setting 432 are distributed over the low load conditions 406 of the work cycle 200 when the auxiliary charge source 320 is not otherwise active. Relatedly, during the low load conditions 406, the primary power source 150 is not significantly loaded and may have the capacity to provide recharging power to the auxiliary power source 320.

In an embodiment, the allocation-conversion routine/module 430 can include a time-based calculation operation 434 that allocates the total required recharging power 412 into the plurality of recharging power shares 436 on the basis of cycle segment times 438 or the temporal duration of the plurality of cycle segments that constitute the work cycle 200. The cycle segment times 438 can be predetermined and can be maintained as part of the instruction set 356 maintained in the work cycle database 352. In the time-based calculation operation 434, the electronic controller 304 can retrieve the cycle segment times 438 and, using the digital counter 354, can gradually and sequentially direct the plurality recharging power shares 436 to the auxiliary power source 320 in accordance with the cycle segment times 438.

In another embodiment, the allocation-conversion routine/module 430 can set the recharging power control settings 432 in accordance with the recharging power level 439 maintained by the recharging process over the duration of the low load condition 406. For example, the duration of the low load condition 406 can be calculated by summing the corresponding cycle segment times 438 maintained in the work cycle database 354. The recharging power level 439 can be established by averaging the total required recharging power 412 over the duration of the low load condition 406 determined by summing the cycle segment time 438.

In a converse embodiment, the cycle segment times 438 can be adjusted based on the total required recharging power 412. For example, to maintain a recharging power level 439 that may be predetermined and set in accordance with the recharging power control setting 432, the allocation-conversion routine/module 430 may adjust the cycle segment times 438 of the cycle segments corresponding to the low load conditions 406. For example, the duration of the loaded and empty swing segments 212, 216 of the earthmoving work cycle 200 may be increased. The adjusted cycle segments prolong the low load conditions 406 of the work cycles to distribute the charge transfer of the total required recharging power 412 over a prolonged period. The recharging power level 439 can be maintained during the prolonged low load condition 406 so the recharging energy accumulates in the auxiliary power source 320 to satisfy the total required recharging power 412.

In another embodiment, the allocation-conversion routine/module 430 can set the plurality of recharging power shares 436 in relation to the power requirements of each of the low load conditions 406 that are applied to the primary power source 150. For example, during the earthmoving work cycle 200, the dump segment 204 in which only the bucket 104 is articulated may consume less electrical power than the loaded and the empty swing segments 212, 216 in which the platform 142 is rotated with respect to the undercarriage 140.

To estimate or obtain the segment power loads 442 for each cycle segment, the allocation-conversion routine/module 430 can include a segment estimation operation 440. The segment power loads 442 can be predetermined or empirically determined and stored as historic data in the power requirements database 350. The electronic controller 304 can retrieve the segment power loads 442 and, in a share setting operation 444, can set the recharging power shares 436 inversely to the segment power loads 442. Inversely setting the recharging power shares 436 to the segment power loads 442 ensures that the primary power source 150 has sufficient capacity to supply electrical power during each of the low load conditions 406 of the work cycle 200. In other words, the segment estimation operation 440 and the share setting operation 444 avoid overdrawing current from the primary power source 150 that could damage the electrochemical cells therein or harm the connections to the power bus 302.

To implement the gradual distribution recharging power from the primary power source 150 in accordance with the calculated recharging power control settings 432 to the auxiliary power source 320, the recharging process 400 can include a recharging power regulation routine/module 450. The recharging power regulation routine/module 450 can be configured to monitor and adjust the flow of electric current in the auxiliary circuit 324. For example, the recharging power regulation routine/module 450 can measure current using the current sensor 332 and responsively adjust the current regulator 330 to increase or decrease the current in accordance with the recharging power shares 436 and/or the recharging power level 438. In another embodiment, the recharging power regulation routine/module 450 can quantize and distribute the recharging power shares 436 from the primary power source 150 to the auxiliary power source 320 by repeatedly opening and closing the electric switch 328, thereby connecting and disconnecting the auxiliary circuit 324 and the primary circuit 326.

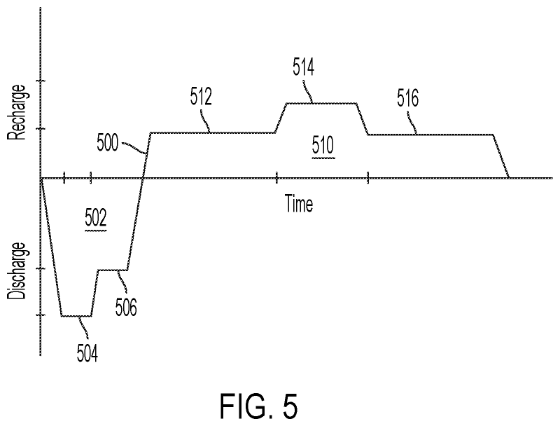

The recharging process 400 results in a more regulated application of charging and discharging events applied to the auxiliary power source 320 that are adapted and modified in accordance with the duration of the work cycle 200. Referring to FIG. 5, there is illustrated a chart graphing the electrical power 500, for example the electric current, discharged from and recharged to the auxiliary power source 320 over the duration of the earthmoving work cycle 200.

The chart may include a discharge event 502 in which the electrical power is discharged from the auxiliary power source 320 and that corresponds to the high load condition 404 occurring during the dig-stroke segment 204 of the work cycle 200. Moreover, the discharge event 502 may be characterized by a peak discharge level 504 during which a relatively large amount of current is discharged from the auxiliary power source 320 and an intermediate discharge level 506 during which a relatively reduced amount of current is discharged. The peak discharge level 504 can coincide with the break-in sub-segment 206 in which the bucket 104 initially penetrates the terrain surface 102 and the power requirements of the earthmoving machine 100 are significant. The intermediate discharge level may coincide with the dig-in sub-segment 208 and the loaded lift sub-segment 210 in which the bucket 104 only displaces material with respect to the terrain surface 102.

Subsequent to the discharge event 502, the auxiliary power source 320 can undertake a recharging event 510 in which electrical power is directed to the auxiliary power source 320. In an embodiment, the recharging power can be provided by or supplied from the primary power source 150, although in other embodiments some or all of the recharging power may be provided from other sources. To avoid power spikes or rapidly charging the auxiliary power source 320, the recharging event 510 is extend over the duration of the low power condition 406. For example, the recharging event 510 can sequentially direct electric energy quantified in accordance with the recharging power control settings 432 between the primary power source 150 and the auxiliary power source 320. The electronic controller 304 can adjust the current regulator 330 to control the current flow and electrical power in the auxiliary circuit 324 to both prolong the recharging event 510 and to limit current spikes, and thus power drawn from the primary power source 150.

In the embodiments in which the recharging power control settings 432 are calculated inversely to the segment power loads 442, the recharging event 510 may be characterized by a first intermediate recharging level 512, a peak recharging level 514, and a second intermediate recharging level 516. In accordance with the chart, the peak recharging level 514 can represent a relatively larger quantity of electrical energy being permitted to flow through the auxiliary circuit 324 to the auxiliary power source 320 and the first and second intermediate recharging levels 512, 516 can represent a relatively lower amount of electrical energy flow. While FIG. 5 illustrates the first and second intermediate recharging levels 512, 516 as equal, in some embodiments, the first intermediate recharging level 512 can exceed the second intermediate recharging level 516 to reflect the different power requirements between the loaded swing segment 212 and the empty swing segment 216.

The peak recharging level 514 can coincide with the dump segment 214 of the earthmoving work cycle 200 and the first and second intermediate recharging levels 512, 516 can coincide with the swing segments 212, 216. Hence, the electric load applied to the primary power source 150 by the recharging event 510 inversely corresponds to the electrical load applied to meet the other requirements of the earthmoving machine 100 at the relevant time. The electronic controller 304 can variably adjust the current regulator 330 to reconfigure the auxiliary circuit 324 to selectively change between supplying the peak recharging level 514 and the intermediate recharging levels 512, 516. The electronic controller 304 can also utilize the digital counter 354 for measuring the duration of peak and intermediate recharging levels 512, 516.

While FIG. 5 charts the electrical power 500 discharged from and recharged to the auxiliary power source 320 as linear, consistent curves, the electrical power 500 at the peak and intermediate levels may have different slopes. For example, where the digital counter 354 is used to temporally allocate the recharging power shares 432 over the duration of the recharging event 510, the peak and intermediate recharging levels 512, 514, 516 can be characterized by jitter or the like.

An advantage of the disclosure over more common arrangements for recharging an auxiliary power supply is the avoidance of applying excessive current rapidly to the auxiliary power supply and thus reduce attrition and degradation. For example, gradually recharging the auxiliary power source 320 may improve cycle life performance over time. Relatedly, the disclosure also avoids applying excessive loads to the primary power source 150 or other recharging supplies resulting in similar benefits. The disclosure may also coordinate the recharging power drawn from the primary power source 150 with the other requirements of the earthmoving machine 100 to improve the operation and effectiveness of the battery management system 300.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An earthmoving machine comprising:
a machine frame supported on a plurality of traction/propulsion devices contacting a terrain surface;
a traction motor operable to drive the plurality of traction/propulsion devices;
a tool linkage attached and movable with respect to the machine frame and coupled to a work tool for engaging the terrain surface;
a hydraulic system including a hydraulic pump for fluidly communicating hydraulic fluid to one or more hydraulic actuators associated with the tool linkage;
a primary power source electrically connect to provide electrical power to the traction motor;
an auxiliary power source electrically connected to the hydraulic system to provide supplemental power to the hydraulic pump; and
an electronic controller configured to conduct a work cycle by moving the tool linkage and the work tool, the work cycle characterized by a high load condition and a low load condition;
the electronic controller further configured to convert a total required recharging power for recharging the auxiliary power source into a recharging power control setting applied during the low load condition and to direct electrical recharging power to the auxiliary power source in accordance with the recharging power control setting.

2. The earthmoving machine of claim 1, wherein the recharging power control setting is determined based on cycle segment times associated with the work cycle.

3. The earthmoving machine of claim 1, wherein the recharging power control settings includes a plurality of recharging power shares determined inversely to a corresponding segment power load.

4. The earthmoving machine of claim 3, wherein the plurality of recharging power shares include at least one recharging power share corresponding to a peak recharging level and at least one recharging power share corresponding to an intermediate recharging level.

5. The earthmoving machine of claim 1, wherein the total required recharging power is set to correspond with the supplemental power provided from the auxiliary power source.

6. The earthmoving machine of claim 5, wherein the supplemental power provided to the auxiliary power source is measured by an auxiliary power sensors associated with the auxiliary power source.

7. The earthmoving machine of claim 5, wherein the supplemental power provided to the auxiliary power source is estimated based on power consumption of the work cycle.

8. The earthmoving machine of claim 1, wherein the total required recharging power is determined to maintain a target charge level of the auxiliary power source.

9. The earthmoving machine of claim 1, wherein the auxiliary power source is a capacitor.

10. The earthmoving machine of claim 1, further comprising a current regulator electrically connected with the auxiliary power source to control the plurality of recharging power shares directed to the auxiliary power source.

11. The earthmoving machine of claim 10, wherein the auxiliary power source and the current regulator are part of an auxiliary circuit which is arranged in parallel with a primary circuit including the primary power source.

12. A method of operating an earthmoving machine comprising:
conducting a work cycle with the earthmoving machine that is characterized by a high load condition and a low load condition;
determining a total required recharging power for recharging an auxiliary power source selectively connected with a primary power source;
converting the total required recharging power to a recharging power control setting corresponding to the low load condition; and
recharging the auxiliary power source in accordance with recharging power control setting.

13. The method of claim 12, wherein the recharging power control setting includes a plurality of recharging power shares allocated over the low load condition.

14. The method of claim 13, wherein the plurality of recharging power shares are determined inversely to a corresponding segment power load associated with the work cycle.

15. The method of claim 12, wherein the recharging power control setting is determined based on cycle segment times associated with the work cycle.

16. The method of claim 12, wherein the step of determining the total required recharging power includes measuring a supplemental power actually discharged from the auxiliary power source during the high load condition.

17. The method of claim 12, wherein the step of determining the total required recharging power includes estimating a supplement power to be discharged from the auxiliary power source during the high load condition.

18. The method of claim 12, wherein the step of determining the total required recharging power includes maintain a target charge level of the auxiliary power source.

19. The method of claim 12, wherein the work cycle includes a dig-stroke segment, a loaded swing segment, a dump segment, and an empty stroke segment.

20. A computer-implemented control system for recharging an auxiliary power source on an earthmoving machine comprising:
a recharge determination routine/module configured to determine total required recharging power for recharging the auxiliary power source after discharging supplemental power during a high load condition of a work cycle; and
an allocation routine/module to convert the total required recharging power into a recharging power control setting to be applied during a low load condition of the work cycle.
